(19) United States
(12) Patent Application Publication
(10) Pub. No.: US 2023/0012700 A1
(43) Pub. Date: Jan. 19, 2023

(54) SYSTEMS AND METHODS FOR OPTIMIZING ELECTRONIC CONTENT DELIVERY FOR NON-MEASURABLE USERS

(71) Applicant: Verizon Media Inc., New York, NY (US)

(72) Inventors: Niklas KARLSSON, Mountain View, CA (US); Ravi KANT, San Jose, CA (US); Qian SANG, Vienna, VA (US); Balaji Srinivasa Rao PALADUGU, San Jose, CA (US); Aaron FLORES, Menlo Park, CA (US); Tularam BAN, Cupertino, CA (US); Hirakendu DAS, Jersey City, NJ (US); Maxim SVIRIDENKO, New York, NY (US)

(73) Assignee: Verizon Media Inc.

(21) Appl. No.: 17/305,688

(22) Filed: Jul. 13, 2021

(51) Int. Cl. G06Q 30/02

(52) U.S. Cl. CPC G06Q 30/0254; G06Q 30/0201; G06Q 30/0275

(57) ABSTRACT

A computer-implemented method for optimizing electronic content delivery for non-measurable users includes receiving a feature vector for each electronic content impression opportunity, receiving a feature vector for each delivered item of electronic content for measurable users, receiving an in-target indication for each delivered item of electronic content for measurable users, estimating a probability that an electronic content impression opportunity with a specified feature vector will meet targeting requirements based on the received feature vectors and the received in-target indications, receiving an in-target threshold value, generating an in-target rate control signal based on a number of total delivered items of electronic content for measurable users and a number of in-target delivered items of electronic content for measurable users, determining whether the estimated probability is greater than the in-target rate control signal, and generating conditions for delivering a new item of electronic content for an electronic content impression opportunity.

### TECHNICAL FIELD

Various embodiments of the present disclosure relate generally to delivering electronic content. More specifically, and without limitation, the present disclosure relates to systems and methods for monitoring, controlling, and/or optimizing electronic content delivery for non-measurable users.

### BACKGROUND

Some online content providers are interested in placing or delivering electronic content, e.g., text, audio, images, video, etc., on websites to drive viewers of the content to visit the providers' web pages, promote products or services, etc. In such a context, the placing or delivery of the content to a viewer can also be referred to as an “impression” of the content. In general, these online content providers set conditions for providing their content, such as a payment to publishers, in such a way as to maximize the total number of events associated with the content, where an event, without loss of generality may be an impression, click, conversion, viewable impression, etc. Such maximization may be improved by ensuring that viewers of the provided content meet a set of criteria determined by the online content provider. Electronic content delivered to viewers meeting online content provider's criteria are said to be “in-target.” In order to improve the efficiency of the provided content and increase the desired outcomes, online content providers have traditionally measured the behavior and attributes of individual users through the use of mechanisms such as cookies, tracking pixels in images, etc., for example, to improve the “in-target” rate of delivered impressions. However, the use of such mechanisms may be less available to online content providers in view of, for example, an increased ability of users to opt-out of such mechanisms, desire to allow users to expressly opt-in to such mechanisms, and so on. That is, online content providers face a need to measure and optimize the efficiency of an online content campaign even when the behavior of many users is less measurable.

The present disclosure is directed to overcoming one or more of these above-referenced challenges.

### SUMMARY OF THE DISCLOSURE

According to certain aspects of the present disclosure, systems and methods are disclosed for optimizing electronic content delivery for non-measurable users.

In one embodiment, a computer-implemented method is disclosed for optimizing electronic content delivery for non-measurable users, the method comprising: receiving a feature vector for each electronic content impression opportunity among a plurality of electronic content impression opportunities, receiving a feature vector for each delivered item of electronic content among a plurality of previously-delivered items of electronic content for measurable users, receiving an in-target indication for each delivered item of electronic content among the plurality of previously-delivered items of electronic content for measurable users, estimating a probability that an electronic content impression opportunity among the plurality of electronic content impression opportunities with a specified feature vector will meet targeting requirements based on the received feature vectors and the received in-target indications, receiving an in-target threshold value, generating an in-target rate control signal based on a number of total delivered items of electronic content for measurable users and a number of in-target delivered items of electronic content for measurable users, determining whether the estimated probability is greater than the in-target rate control signal, and generating conditions for delivering a new item of electronic content for an electronic content impression opportunity among the plurality of electronic content impression opportunities.

In one or more embodiments, the computer-implemented method for optimizing electronic content delivery for non-measurable users may further comprise: determining a feature vector for a new delivered item of electronic content for a measurable user, updating the estimated probability that an electronic content impression opportunity among the plurality of electronic content impression opportunities with the specified feature vector will meet targeting requirements based on the new delivered item of electronic content for a measurable user, updating the number of total delivered items of electronic content for measurable users based on the new delivered item of electronic content for a measurable user, updating the number of in-target delivered items of electronic content for measurable users based on the new delivered item of electronic content for a measurable user, and adjusting the in-target rate control signal based on the updated number of total delivered items of electronic content for measurable users and the updated number of in-target delivered items of electronic content for measurable users.

In one or more embodiments, the targeting requirements may include one or more of a requirement that the electronic content is delivered to a user up to a specified maximum number of times within a specified period of time, a requirement that demographics of a user receiving the electronic content match predetermined demographics, a requirement that prior behavior and activity of the user receiving the electronic content match predetermined behavior and activity criteria, and a requirement that repeated delivery of the electronic content to a user be separated by at least a specified period of time.

In one or more embodiments, the specified period of time may be one of an hour, a number of hours, a day, or a number of days.

In one or more embodiments, the measurable users may be a subset of all users receiving the electronic content, and receipt of the electronic content by the measurable users may be recorded.

In one or more embodiments, the measurable users may be determined by way of an opt-in by each measurable user among the measurable users, and each measurable user among the measurable users may be measured by way of one or more of a device identifier of a device of the measurable user, or a hashed email address of the measurable user.

In one or more embodiments, generating the conditions for delivering a future item of electronic content may be based on a binary result of determining if the estimated probability is greater than the in-target rate control signal.

In one or more embodiments, generating the conditions for delivering a future item of electronic content may be based on the estimated probability.

In accordance with another embodiment, a system is disclosed for optimizing electronic content delivery for non-measurable users, the system comprising: a data storage device storing instructions for optimizing electronic content delivery for non-measurable users in an electronic storage medium; and a processor configured to execute the instructions to perform a method including: receiving a feature vector for each electronic content impression opportunity among a plurality of electronic content impression opportunities, receiving a feature vector for each delivered item of electronic content among a plurality of previously-delivered items of electronic content for measurable users, receiving an in-target indication for each delivered item of electronic content among the plurality of previously-delivered items of electronic content for measurable users, estimating a probability that an electronic content impression opportunity among the plurality of electronic content impression opportunities with a specified feature vector will meet targeting requirements based on the received feature vectors and the received in-target indications, receiving an in-target threshold value, generating an in-target rate control signal based on a number of total delivered items of electronic content for measurable users and a number of in-target delivered items of electronic content for measurable users, determining whether the estimated probability is greater than the in-target rate control signal, and generating conditions for delivering a new item of electronic content for an electronic content impression opportunity among the plurality of electronic content impression opportunities.

In accordance with another embodiment, a non-transitory machine-readable medium storing instructions that, when executed by the a computing system, causes the computing system to perform a method for optimizing electronic content delivery for non-measurable users, the method including: receiving a feature vector for each electronic content impression opportunity among a plurality of electronic content impression opportunities, receiving a feature vector for each delivered item of electronic content among a plurality of previously-delivered items of electronic content for measurable users, receiving an in-target indication for each delivered item of electronic content among the plurality of previously-delivered items of electronic content for measurable users, estimating a probability that an electronic content impression opportunity among the plurality of electronic content impression opportunities with a specified feature vector will meet targeting requirements based on the received feature vectors and the received in-target indications, receiving an in-target threshold value, generating an in-target rate control signal based on a number of total delivered items of electronic content for measurable users and a number of in-target delivered items of electronic content for measurable users, determining whether the estimated probability is greater than the in-target rate control signal, and generating conditions for delivering a new item of electronic content for an electronic content impression opportunity among the plurality of electronic content impression opportunities.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an illustrative electronic content delivery system, according to one or more embodiments.

FIG. 2 depicts an illustrative online optimization control system for controlling optimization of an electronic content delivery campaign operating in an online content network, according to one or more embodiments.

FIG. 3 depicts an exemplary process for targeted delivery of electronic content, according to one or more embodiments.

FIG. 4 is a block diagram of an in-target rate prediction module, according to one or more embodiments.

FIG. 5 is a block diagram of a portion of an illustrative optimization control system for manually controlling optimization of an electronic content delivery campaign for non-measurable users, according to one or more embodiments.

FIG. 6 is a block diagram of a portion of an illustrative optimization control system for automatically controlling optimization of an electronic content delivery campaign for non-measurable users, according to one or more embodiments.

FIG. 7 depicts a flowchart of a method of optimizing electronic content delivery for non-measurable users, according to one or more embodiments.

FIG. 8A is a block diagram of a beta actuator as a portion of an illustrative optimization control system for automatically controlling optimization of an electronic content delivery campaign for non-measurable users, according to one or more embodiments.

FIG. 8B includes a plot that shows a relationship between the in-target rate estimate and a bid allocation signal for a method of optimizing electronic content delivery for non-measurable users, according to one or more embodiments.

FIG. 9 depicts a flowchart of a method of generating a bid allocation signal in a method of optimizing electronic content delivery for non-measurable users, according to one or more embodiments.

FIG. 10 is a block diagram of a portion of an illustrative optimization control system for automatically controlling optimization of an electronic content delivery campaign for non-measurable users, according to one or more embodiments.

FIG. 11 depicts a flowchart of a method of optimizing electronic content delivery for non-measurable users, according to one or more embodiments.

FIG. 12 depicts a process flow of a method of optimizing electronic content delivery for non-measurable users, according to one or more embodiments.

FIG. 13A includes a plot that shows an optimization control signal for a method of optimizing electronic content delivery for non-measurable users, according to one or more embodiments.

FIG. 13B includes a plot that shows a relationship between a specified desired in-target rate and an in-target rate estimate for a method of optimizing electronic content delivery for non-measurable users, according to one or more embodiments.

FIGS. 14A and 14B depict user interfaces for user control of an desired in-target rate in a method of optimizing electronic content delivery for non-measurable users, according to one or more embodiments.

FIG. 15 depicts a user interface for user control for generating reports of an electronic content delivery campaign in a method of optimizing electronic content delivery for non-measurable users, according to one or more embodiments.

FIG. 16 is a block diagram of an example computing device in which various embodiments of the present disclosure may be employed.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, the term “impression” may refer to an instance of providing or delivering of content within an online campaign. Such content may include, but is not otherwise limited to images, audio, video, advertisements, or advertising content. As used herein, the term “event” generally may refer to an impression that meets one or more criteria, e.g., an in-view event (or impression), an in-target event (or impression), conversion event (or impression), click event (or impression), completed video event (or impression), and the like. A content provider may define virtually any criteria to constrain the definition of events.

The term “event type” may refer to a particular type of event. For instance one event type may be an in-view event, while another event type may be an in-target event. Other event types include, but are not limited to click events (or simply clicks), conversion events (or simply conversions), completed video events, and the like. An in-view event may be an event or impression that satisfies one or more viewability criteria, e.g. an in-view event in association with an online display campaign may be an impression where at least 50% of the pixels of the content are in view for more than one second.

The term “in target” may refer to events that meet one or more criteria determined by the provider of the electronic content. Such criteria may include one or more of: demographic criteria, such as age, gender, income, geographic location, and so on, behavior and activity criteria, such as prior purchases of particular products or services, web sites visited, social media posts created or viewed, entertainment viewed or attended—including music television, movies, etc., and prior exposures to electronic content, including a length of time since the last exposure to a particular electronic content, and a number of exposures to a particular electronic content—whether cumulative or over a designated period of time. For example, a content provider may want to limit the number of exposures to a particular electronic content over a certain period of time, such as over the previous 24 hours, week, or month. This is sometimes known as “frequency capping” and may reduce user fatigue, boredom, or annoyance with repeated viewings of the same content and may increase the effectiveness of the delivered content.

The term “event rate” may refer to the likelihood or probability that a particular delivered item of electronic content or “impression” is, or will become, an event of an event type of interest, or simply an event of interest. For instance, in one embodiment where in-view events are of interest, 100 impressions are provided to 100 separate users. Furthermore, 73 of the 100 provided impressions are determined to be in-view events, and the in-view event rate is determined or estimated as 0.73. Briefly, the in-view event rate is estimated as 0.73 because the average likelihood or probability for each of the 100 impressions to be an in-view event is 0.73. Thus, an event rate estimate may be determined as a moving average of the inverse of the ratio of the total number of impressions provided in a time-interval to the number of the impressions that are, or become, an event of interest. In at least one embodiment as discussed below, the event rate estimate may be based on a sampled number of impressions and a sampled number of events of interest.

Various event rate types may be defined, such as but not limited to in-view rates, in-target rates, click-through rates, conversion rates, completed video event rates, and the like. In some embodiments, the term event rate may refer to an overall event rate. In other embodiments, the term event rate may refer to a generalized event rate. In still other embodiments, the term event rate may refer to an event rate type. As used throughout, event rates may be referred to simply as rates.

An online campaign may be segmented into a plurality of campaign segments, or simply segments. In some embodiments, at least one of the plurality of campaign segments includes a plurality of targeted users, such as but not limited to a user group, target audience, or the like. In at least one embodiment, at least one of the plurality of campaign segments includes only a single targeted user.

The term “campaign-level event rate” may refer to an event rate for an online campaign. In contrast, the term “segment-level event rate” may refer to an event rate for one or more segments of the online campaign. In at least one embodiment, a campaign-level event rate is an estimate of the event rate for the entire, or whole, campaign based on a number of sampled impressions and a number of sampled events of interest, for the campaign. Here, the number of sampled impressions and the number of sampled events are the sum of the impressions and events, respectively, across each of the segments associated with the campaign. In contrast, the segment-level event rate may be an event rate estimate based on the numbers of sampled impressions and events at the segment level. For example, an event rate for Segment A of a campaign is estimated based on the number of sampled impressions and the number of sampled events of interest associated with Segment A only.

In some circumstances, a content provider may provide payment for the placement of electronic content with a publisher, such as on the publisher's web page. Placement of such content may require that the content provider participate in an auction with other content providers by specifying an amount, or “bid,” the content provider is willing to pay for the placement. As used herein, the term “bid allocation” may refer to the probability that a campaign participates in the auction for an impression. Thus, a bid allocation may refer to the percentage of auctions that a content provider, or another party, would like to participate to “win” impressions for a particular segment in an online campaign. A bid may include both a bid allocation and a bid price. For instance, for a particular bid, if the bid allocation is 1, then the campaign bids for all impressions. That is, one bid is associated with one impression opportunity. If the campaign's bid price is greater than all other provided bid prices, the campaign will win each bid impressions. If the bid allocation is 0.1, the campaign participates in 10% of the auctions. Depending on whether the bid price is high enough, as compared to other bid prices, the campaign may or may not win those 10% of the impressions.

As used herein, the term “plant” may refer to an object to be controlled, and the term “plant response curve” may refer to a description of the relationship between a control signal applied to the plant and its response. For instance, in various embodiments, the plant response curve refers to the function or relationship between a control signal (u) and an event rate (p). Thus, in functional notation referred to in the various embodiments, the function p(u) may be a plant or at least refer to a plant response curve. The gain of an optimization control system, or a plant, may refer to the derivative of the plant event rate p, e.g. gain(u)=dp(u)/du.

As used herein, the term “feature vector” may refer to a vector representation of all the contextual attributes of a given event. For example, a supervised machine learning model may consume a stream of data in the form of feature vectors along with a label for training. At scoring time, the model may consume a feature vector and output a prediction.

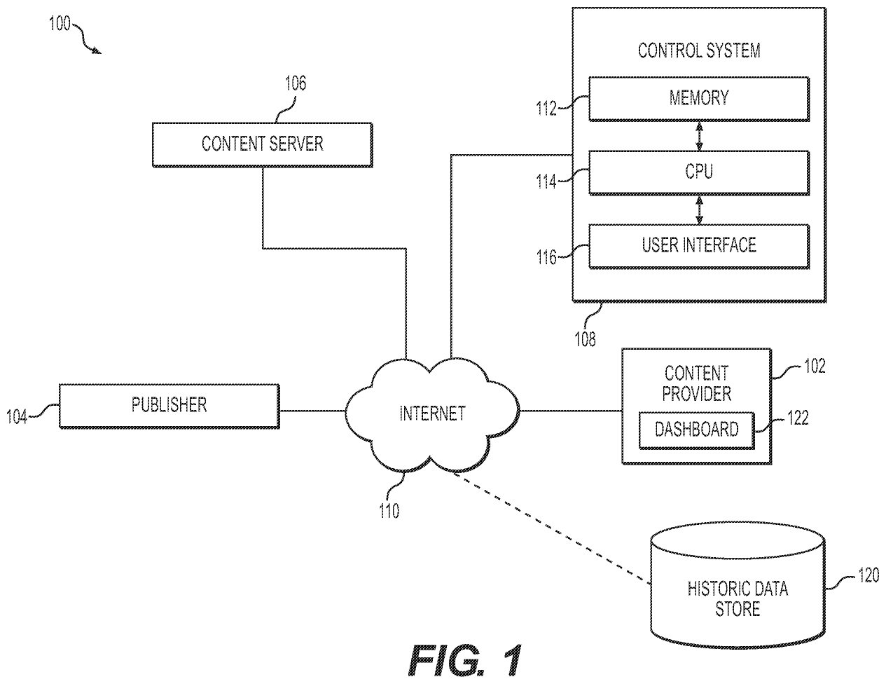

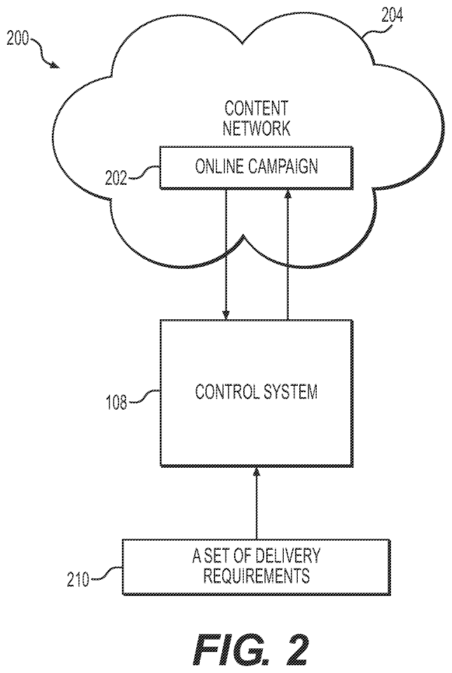

Any suitable system infrastructure may be put into place to allow optimizing electronic content delivery for non-measurable users. FIGS. 1 and 2, and the following discussion, provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIGS. 1, 2, and 16. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or pre-programmed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Various embodiments are directed towards optimizing event rates for content delivered and/or provided within an online campaign. When deciding whether to provide content in an online campaign, content providers may attempt to allocate a finite budget to provide their content in such a way as to maximize the total number of events. Such maximized events may include various event types, such as but not limited to clicks, conversions, viewable impressions, in-target impressions, completed-video impressions, and the like. Events related to delivered content may be increased if the content is delivered to users meeting criteria determined by an online content provider, such as demographics, prior purchase history, geographic location, and so on. Impressions provided to viewers meeting online content provider's criteria are said to be “in-target.” In order to improve the efficiency of the provided content and increase the desired outcomes, online content providers have traditionally measured the behavior and attributes of individual users through the use of mechanisms such as cookies, tracking pixels in images, etc., for example to improve the “in-target” rate of delivered impressions. However, the use of such mechanisms may be less available to online content providers in view of, for example, increased regulation, an increased ability of users to opt-out of such mechanisms, a requirement that users expressly opt-in to such mechanisms, and so on.

Accordingly, content providers may wish to allocate their budget such that an “in-target” rate is greater than or equal to a minimum “in-target” rate, e.g. a desired “in-target” rate. In the past, content providers may have broadly measured the attributes and behaviors of the recipients of electronic content, but such broad measuring may be less available as regulations and the ability of users to prevent measuring change. In such cases, providers may employ panels of “measurable” users who agree to be measured in this way—either through the default options of their service provider or platform, their own selected options for sharing attribute and behavior information, or an explicit opt-in for being measured. The measured “in-target” rate for a “measurable” panel during a campaign may be used to approximate the “in-target” rate for all targeted users and this approximated rate may then be used to adjust the parameters of the campaign to meet the “in-target” threshold. All content, or “impressions,” delivered to measurable users may be considered to be “measurable impressions.” In-target content, or “in-target impressions,” delivered to measurable users may be considered to be “measurable in-target impressions.”

The embodiments disclosed herein increase the likelihood that a campaign-level “in target” rate for all users receiving online electronic content meets or exceeds an “in-target” rate threshold. That is to say, an “in-target” rate (associated with content that satisfies one or more criteria to be considered as being delivered to targeted users) for a campaign is greater than or equal to an “in-target” rate threshold (or simply a rate threshold). This may be accomplished by measuring an “in-target” rate for a panel of measurable users and applying this measured rate to all (measurable and non-measurable) users. Throughout, such “in-target” rates may be referred to as campaign-level “in-target” rates.

Systems and methods are disclosed that adaptively allocate bids for providing the online content within the campaign. The campaign-level “in target” rate is estimated based, at least in part, on an “in-target” rate for a measured panel of users, and provided as a real-time feedback signal. For example, the “in-target” rate for the panel of measured users may be based on a number of attributes of the measured users or on known activities or behaviors of the measured users. This feedback signal is employed to dynamically update the bid allocations for the campaign, which in turn varies or updates the campaign-level “in-target” rate. Thus, such feedback enables the control of the campaign-level “in-target” rate and ensures that the campaign-level “in-target” rate meets or exceeds the “in-target” rate threshold.

In addition, a controller for the campaign, whether a human being or a computer processor, may receive the “in-target” rate threshold from, for example, the content provider and may adjust a control signal based on, for example, a difference between the received “in-target” rate threshold and a ratio of known measurable impressions and known measurable in-target impressions, such that the estimated in-target rate, based on the ratio, meets or exceeds the desired in-target rate.

To control “in-target” rates, the number of total impressions, as well as the number of events, of delivered online content may be temporally sampled across the campaign. Based on the volume of sampled impressions, the campaign-level “in-target” rate may be estimated. The “in-target” rate estimate may be employed as feedback, to update a control signal that may dynamically adapt the content provider's criteria, such as bid prices submitted at auction, for placement of content in the campaign. More specifically, the control signal may be updated such that the estimated campaign-level “in-target” rate is greater than or equal to the “in-target” rate threshold.

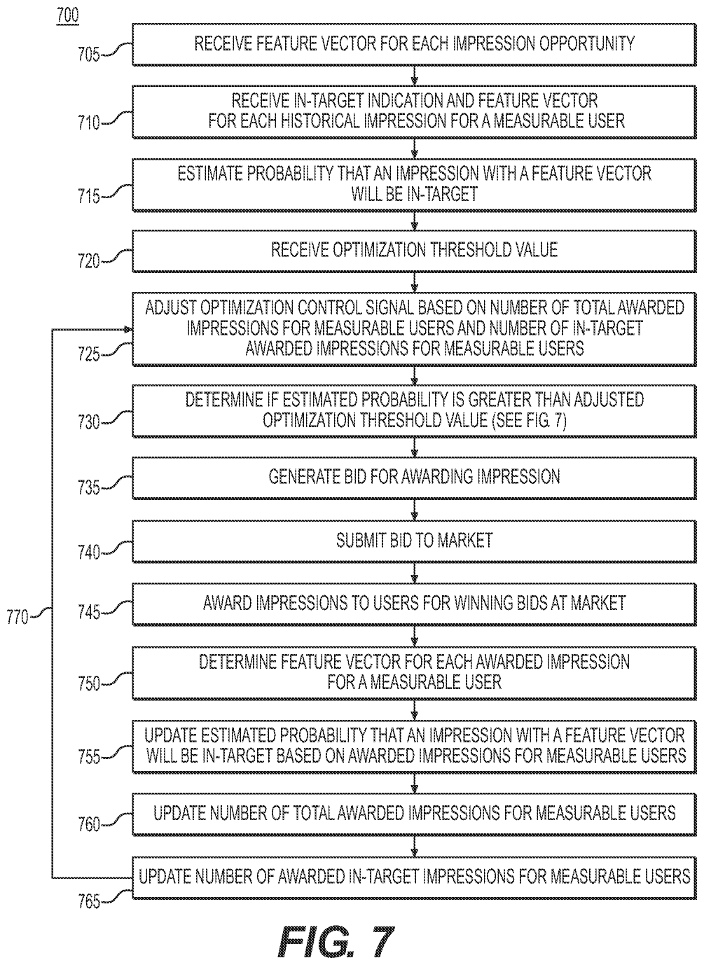

Systems that employ feedback (or feedback-based control systems), such as optimization control systems 108, 500, 600, and 1000, of FIGS. 1, 5, 6, and 10, respectively, as well as various methods, such as but not limited to methods 700, 800, and 1100 of FIGS. 7, 8, and 11, respectively, may enable a content provider to specify a minimum “in-target” rate (the “in-target” rate threshold). For instance, the content provider may base the “in-target” rate threshold on the budget for an online campaign. The various embodiments may automatically allocate offers or auction bids for providing content in such a way to meet or exceed the rate threshold. Furthermore, based on the feedback, the various embodiments may further enhance the effectiveness of controlling the various “in-target” rates of the campaign by selectively determining content placements to which offers or bids may be allocated.

In the various embodiments presented herein, an optimization control system may be employed to control the allocation of offers or bids, resulting in more control of “in-target” rates, preferably resulting in a desired “in-target” rate. As noted above, the smoothly controlled “in-target” rates may be estimated and provided, via a feedback loop, to an “in-target” rate controller of the optimization control system. The “in-target” rate controller may update a control signal based on the feedback loop. The updated control signal may be provided, for example, to an actuator of the optimization control system. The actuator may update an offer or bid allocation for the desired delivery of electronic content, based on at least the control signal. The offer or bid allocations may be employed to generate bids to provide content to targeted users.

In some embodiments, rather than applying a threshold condition based on the control signal, the actuator may employ a continuous function, or map, to update the offer or bid allocations for the content based on a control signal. In an exemplary but non-limiting embodiment, the continuous function may be associated with the beta distribution, often applied in probability theory. However, it should be noted that, even though a statistical distribution may be employed to generate a relationship between a control signal and an allocation signal, the various embodiments may not include a stochastic nature. Rather, the various embodiments may provide smooth, predictable, and responsive control of “in-target” rates for an online campaign. Furthermore, the control signal may intuitively be interpreted as a “soft” or “fuzzy” threshold value for the “in-target” rate.

Reference will now be made in detail to illustrative embodiments of the invention, examples of which are illustrated in the accompanying drawings. Wherever possible, the same reference numbers will be used throughout the drawings to refer to the same or like parts.

### Exemplary Operating Environments

FIG. 1 depicts an illustrative content delivery system 100, in accordance with embodiments of the present disclosure. As shown in FIG. 1, content delivery system 100 may include one or more content providers 102, publishers 104, content servers 106, and optimization control systems 108 that are in communication with one another through a network, such as the Internet 110. The number and orientation of the computing components in FIG. 1 is provided for purposes of illustration only. Any other number and orientation of components is possible. For example, one or more content providers 102, publishers 104, content servers 106, optimization control systems 108, and historic data stores 120 may be combined or co-located and/or communicate directly with one another, instead of over Internet 110. The components of FIG. 1 may include any type or configuration of computers and/or servers, such as, for example, a server cluster, a server farm, load balancing servers, distributed servers, etc. In addition, each component may include one or more processors, memories or other data storage devices (i.e., computer-readable storage media), such as hard drives, NOR or NAND flash memory devices, or Read Only Memory (ROM) devices, etc., communications devices, and/or other types of computing elements.

Content providers 102 represent computing components associated with entities having online content that the entities desire to deliver to online users. In some embodiments, the content with which the content providers 102 are associated includes targeted content. Targeted content can include, for example, marketing content (e.g., banner content, pop-up content, etc.). Content providers 102 may interact with publishers 104, content servers 106, and/or optimization control systems 108 through the Internet 110. Thus, content provider 102 may be able to communicate content delivery information, such as content information, targeting information, user information, budget information, bidding information, etc., to other entities in content delivery system 100. Dashboard 122 can be configured to present information concerning content delivery system 100 and, in particular, existing or potential content delivery campaigns, also referred to herein as segment groups or tract groups, and associated campaign segments or tracts that define a target audience for the segments of the campaign. For instance, the campaign may include a plurality of campaign segments or tracts, each associated with a target audience. Such information that dashboard 122 may present can include, for example, current real-time event rates, such as but not limited to campaign-level and segment-level event rates, rate thresholds, offer or bid allocations for the segments, control signal values, and the like.

In addition to presenting information, dashboard 122 may enable a user to provide information, data, signals, configuration parameters, or the like. For instance, a user may provide and/or update a rate threshold via dashboard 122. A user may additionally provide and/or update configuration parameters, such as but not limited to controller configuration parameters, actuator configuration parameters, rate-estimator configuration parameters, and the like.

Publishers 104 represent computing components associated with entities having inventories of available online content space. For example, publishers 104 may include computing components associated with online media providers, search engines, e-mail programs, web-based applications, web pages, or any computing component or program having online user traffic. Publishers 104 may interact with content providers 102, content servers 106, and/or controllers 108 via the Internet 110. Thus, publishers 104 may be able to communicate inventory information, such as site information, demographic information, cost information, etc., to other computing components in system 100.

Content servers 106 may include servers or clusters of servers configured to process content delivery information from content provider 102 and/or inventory information from publishers 104, either directly or indirectly. In certain embodiments, content servers 106 may be remote web servers that receive content information from content provider 102 and serve content to be placed by publishers 104 on websites maintained, controlled, or owned by publishers 104. Content servers 106 may be configured to serve content across various domains of publishers 104, for example, based on content delivery information provided by content providers 102. Content servers 106 may also be configured to serve content based on contextual targeting of web sites, search results, and/or user profile information, all of which can be utilized in determining one or more segments defining the target audience for the content. In some embodiments, content servers 106 may be configured to serve content based on one or more signals generated by optimization control systems 108.

Historic data store 120 can include historic information concerning each item of electronic content or impression that is delivered within content delivery system 100, including: a price at which each impression was delivered, such a price may correspond with the clearing price of each impression; additional circumstances that the impression leads to (e.g., click, conversion, view, etc.); and user information for the impression (e.g., website, location information, demographic information, etc.).

Optimization control systems 108 may include computing systems that may be configured to receive information from computing components in system 100, process the information, and generate various outputs (e.g., the control signal discussed herein) to be sent to other computing components in system 100, according to the illustrative methods described herein. Various embodiments of optimization control systems are described throughout. However, briefly, here optimization control system 108 may enable a content provider to specify a minimum “in-target” rate (the rate threshold). optimization Control system 108 may automatically allocate bids for providing content in such a way to meet or exceed the “in-target” rate threshold, thus possibly enhancing the effectiveness of controlling various “in-target” rates for the online campaign.

Optimization control systems 108 may include any type or combination of computing systems, such as clustered computing machines and/or servers, including virtual computing machines and/or virtual servers. Optimization control systems 108 may include, for example, implementations of the AdLearn optimization engine offered by Verizon Media of New York, N.Y. In some embodiments, optimization control systems 108 may include an assembly of hardware, including a memory 112, a central processing unit (“CPU”) 114, and/or a user interface 116. Memory 112 may include any type of RAM or ROM embodied in a physical, computer-readable storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory, for example to perform the methods and processes discussed in detail herein. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, graphical user interface, touch-screen or pad, keyboard, and/or mouse. In other embodiments, optimization control systems 108 may include virtual representations of hardware operating, for example, on a virtualization server.

FIG. 2 depicts an illustrative online content delivery environment 200 for controlling an event rate for online campaign 202 operating in an online content network 204, in accordance with various embodiments of the present disclosure.

Content network 204 may include a network or collection of one or more content providers 102, one or more publishers 104, content servers 106, optimization control systems 108, or other components of system 100 of FIG. 1. Elements of content network 204 may operate to receive requests for content (e.g., impression requests) associated with online campaign 202, e.g., from publishers 104 such as websites or other computing components with an inventory of available content space. Content network 204 may also group content requests for various content delivery tactic groups, e.g., according to impressions to be “targeted” based on a combination of attributes defined by the content requests. Content network 204 may also accept bids (e.g., from one or more optimization control systems 108) on the content requests and process the bids to serve content (e.g., targeted content) to the content requests.

Any number or type of online campaign 202 may be operated within content network 204, across various content servers and domains associated with the Internet. Online campaign 202 may be a segmented or an un-segmented campaign. Online content delivery environment 200 may be implemented by one or more of the content providers 102, publishers 104, content servers 106, and/or optimization control systems 108 described in FIG. 1. For example, online content delivery environment 200 may represent the interaction of one or more optimization control systems 108 with other computing components in system 100.

In one embodiment, online content delivery environment 200 may include one or more instances of optimization control system 108. Optimization control system 108 may comprise computers or servers connected to the Internet. For illustrative purposes, optimization control system 108 is illustrated outside content network 204 in FIG. 2. In some embodiments, optimization control system 108 is included in content network 204. In other embodiments, optimization control system 108 is outside of content network 204. Such computers or servers may be configured as described with respect to optimization control system 108, as depicted by FIG. 1, or in any other suitable configuration. Alternatively, optimization control system 108 may be implemented by software modules executed by CPUs 114 of optimization control system 108. Optimization control system 108 may be embodied entirely in hardware, entirely in software, or in any combination of hardware and software implemented across any number of computing devices.

Optimization control system 108 may be provided with a set of delivery requirements 210, which may be adjustable design parameters set by a user. For instance, the set of delivery requirements 210 may include an “in-target” rate threshold and/or any number of configuration parameters, such as but not limited to controller configuration parameters, actuator configuration parameters, rate-estimator configuration parameters, and the like, as discussed herein. The set of delivery requirements 210 may be implemented by optimization control system 108.

Various embodiments of optimization control system 108 are discussed in conjunction with optimization control systems 500, 600, and 1000, of FIGS. 1, 5, 6, and 10, as well as methods 700, 800, and 1100 of FIGS. 7, 8, and 11, respectively. However, briefly here, optimization control system 108 controls the “in-target” rate for content delivered to online campaign 202. In some embodiments, the controlled “in-target” rate may be an average rate of delivered impressions satisfying one or more predetermined criteria set by the content provider or by another entity. For instance, optimization control system 108 may ensure that a campaign-level “in target” rate for the delivered content meets or exceeds a minimum “in-target” rate, i.e., a rate threshold. In some cases, providers may employ panels of “measurable” users who agree to be measured—either through the default options of their service provider or platform, their own selected options for sharing attribute and behavior information, or an explicit opt-in for being measured. The measured “in-target” rate for a “measurable” panel during a campaign may be used to approximate the “in-target” rate for all targeted users and this approximated rate may then be used to adjust the parameters of the campaign to meet the “in-target” threshold.

Optimization control system 108 may allocate offers or bids for providing the online content within online campaign 202. The campaign-level “in target” rate may be estimated, such as through the use of a “measurable panel,” and provided as a real-time feedback signal. This feedback signal may be employed to dynamically update the offer or bid allocations for the campaign, possibly leading to variations of the campaign-level “in target” rate. Thus, such feedback may enable optimization control system 108 to control the campaign-level “in target” rate of online campaign 202 and may ensure that the campaign-level “in target” rate meets or exceeds the “in target” rate threshold.

To control the “in target” rate, optimization control system 108 may temporally sample, across the campaign segments, the number of total impressions, as well as the number of “in target” impressions, of delivered content, such as for a “measurable panel” as an estimate or proxy for delivered content for all users. Based on the volume of sampled impressions, the campaign-level “in target” rate may be estimated. Optimization control system 108 may employ these “in target” rates, as feedback to update a control signal that dynamically adapts bid allocations for the campaign, such that the estimated campaign-level “in target” rate is greater than or equal to the “in target” rate threshold.

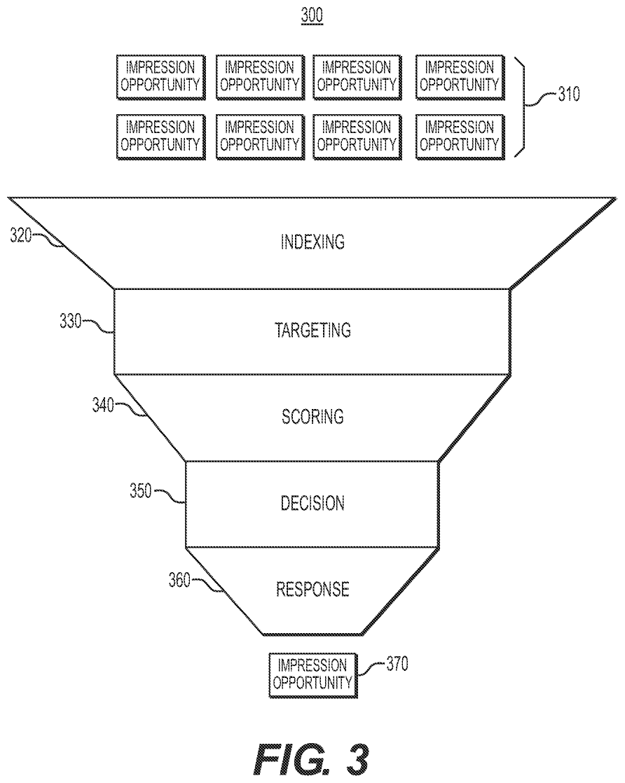

Generally, a provider of electronic content may wish to ensure that the content is delivered to users having certain desirable attributes. As discussed above, such attributes may include, for example, demographic criteria, and prior exposures to electronic content. That is, the content provider may prefer targeted delivery of items of electronic content. FIG. 3 depicts an exemplary process for targeted delivery of electronic content, according to one or more embodiments.

As shown in FIG. 3, a process of targeted delivery of electronic content may begin with a plurality of electronic content impression opportunities 310, which may include, for example, impression requests or bid requests. The impression opportunities 310 may then proceed through a number of operations to determine which items of electronic content may be delivered to particular users. For example, in operation 320, the impression opportunities 310 may first be indexed according to certain attributes of the impression opportunities, such as, for example, a segment of a campaign to which the impression opportunities belong, publication information for the impression opportunities, geographic attributes of the impression opportunities, and so on. The impression opportunities 310 may then enter an iterative targeting operation 330, in which impression opportunities may be repeatedly filtered according to one or more requirements of the campaign, such as pacing, etc. The remaining impression opportunities 310 may then be assigned a score in operation 340, such as based on event rates, context attributes of the placement of the electronic content for the impression opportunities, and user-based attributes. Computation of a bid allocation for an individual impression opportunity may be based on both a campaign level control signal and an impression-level event rate probability, which may be estimated. The score in operation 340 may be the same as the event rate probability and may be computed based on a feature vector, such as may be available for both measurable and non-measurable users. A decision on whether to bid on a placement of an item of electronic content for each impression opportunity may be reached in operation 350. Finally, a response to an offer or bid request may be reached in operation 360. The result may be one or more impression opportunities 370 for which an offer or bid for placement in a campaign for delivery to targeted users may be sought.

### In-Target Rate Optimization Control Systems

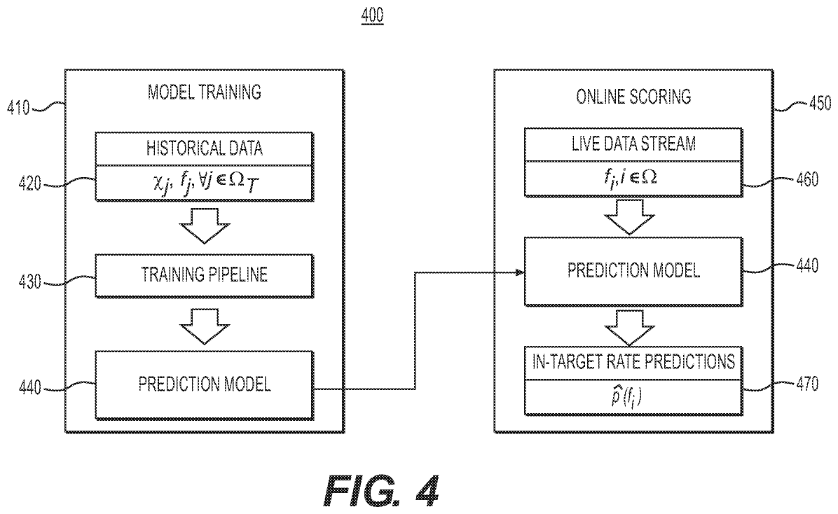

FIG. 4 is a block diagram of an in-target rate prediction module 400, according to one or more embodiments. In one or more embodiments, an in-target rate for impression opportunities may be predicted based on historical in-target indications and associated feature vectors for historical content impressions sent to users, such as measurable users. For example, the historical content impression data may include a set of awarded impressions j in a dataset of impressions Ω_{T} for measurable users. For each awarded impression j, the data may include an “in-target” indication xⱼ and a corresponding feature vector fⱼ. As shown in FIG. 4, in-target rate prediction may include a model training operation 410 and an online scoring operation 450. Model training operation 410 may include receiving historical impression data 420 and processing historical impression data 420 by training pipeline 430 to generate an in-target prediction model 440. For example, in-target rate prediction model 440 may be trained using training pipeline 430. Pipeline 430 may use any suitable algorithm to process historical impression data 420, such as, for example, a machine learning algorithm, to process historical impression data 420 and output prediction model 440. Examples of machine learning algorithms include logistic regression, multi-layer perceptrons and related deep neural network models, support vector machines etc. The choice of which algorithm to use may depend on the precise application, nature of the data, and on the computational resources available, as would be understood by one of ordinary skill in the art according to the available algorithmic choices and the tradeoffs involved in each choice. Prediction model 440 produced by pipeline 430 may then be used to predict the in-target rate of future awarded impressions, such as by online scoring module 450. For example, a live stream of data 460 for impression opportunities i in a dataset of impression opportunities Ω may include a feature vector fᵢ of attributes for each impression opportunity. Prediction model 440 may be retrained periodically. The frequency of retraining may vary from, for example, once a day, to once every few hours, or any other suitable time interval.

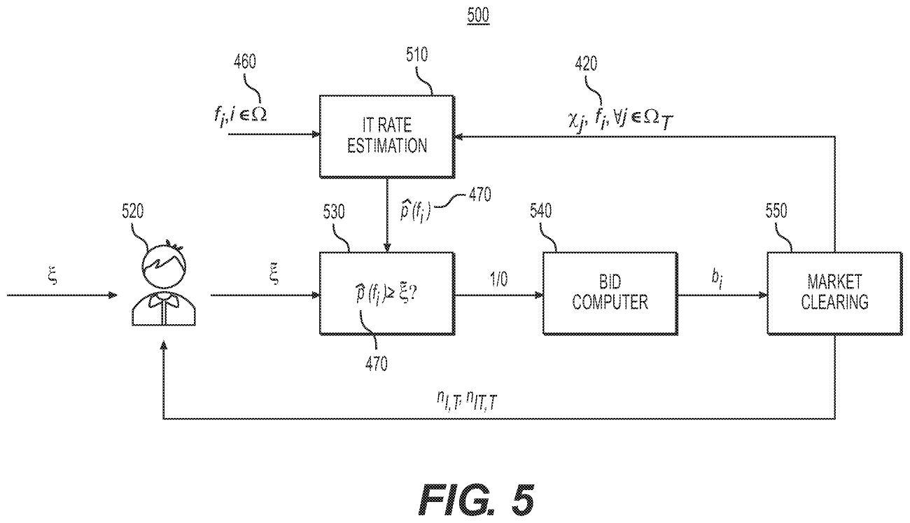

FIG. 5 is a block diagram of a portion of an illustrative optimization control system 500, for manually controlling optimization of an electronic content delivery campaign for non-measurable users, according to one or more embodiments. Generally, an electronic content delivery campaign may be used to provide content to both measurable and non-measurable users. However, an optimization control system, such as optimization control systems 500, 600, or 1000 discussed below, may include training of an in-target probability prediction model for “in-target estimation.” Through this training phase, a distinction may be made between measurable and non-measurable users. However, once the model is trained, such as based on historical impressions associated with measurable users, the delivery of electronic content may be applied similarly to all users whether or not the users are measurable. As discussed above, a content provider may wish to control a campaign to ensure that the campaign-level “in-target” rate meets or exceeds a predetermined threshold. By doing so, the content provider may ensure that the impressions are delivered to the most desirable users.

As shown in FIG. 5, optimization control system 500 may include an “in-target” rate estimation module 510. “In-target” rate estimation module 510 may receive a feature vector fᵢ of attributes for each impression opportunity i among all in a dataset of impression opportunities Ω. “In-target” rate estimation module 510 may also receive, from market clearing module 550, historical content impression data for a set of awarded impressions j in a dataset of impressions Ω_{T} for measurable users. For each awarded impression j, the data may include an “in-target” indication χj and a corresponding feature vector fⱼ. From the received metrics, “in-target” rate estimation module 510 may generate a probability p\hat{ } that an impression will be in-target based on a corresponding user feature vector.

As shown in FIG. 5, a manual controller 520 may receive, such as from content provider 102, an desired in-target rate value ξ specifying a minimum percentage of awarded impressions that are expected to be “in-target” based on content provider 102's desired user attributes. Manual controller 520 may also receive, from market clearing module 550, a number n_{I,T} of awarded impressions delivered to measurable users in the current campaign—i.e., the number of measurable impressions—and a number n_{IT,T} of in-target impressions among the measurable impressions in the current campaign. Based on the received information, manual controller 520 may produce a campaign-level in-target rate control signal \tilde{ξ}. The control signal \tilde{ξ} may be applied as a threshold condition 530 towards in-target probability \hat{p}, generated by the “in-target” rate estimation module 510. The campaign-level in-target rate control signal may be produced in part through intervention by a human campaign administrator. 5A determination 530 whether the estimated probability p\hat{ }, as determined by estimation module 510, meets or exceeds the threshold value \tilde{ξ} is made. Based on this determination 530, a binary (1 or 0, true or false) value may be provided to bid computer 540.

If the binary value provided to bid computer 540 by determination 530 is “false” then bid computer 540 may not submit a bid for the impression opportunity. Alternatively, if the binary value provided to bid computer 540 by determination 530 is “true” then bid computer 540 may submit a bid for the impression opportunity based on factors such as, for example, details of the impression opportunity, a predetermined bidding strategy, and the competitive landscape.

Market clearing module 550 may receive the bid from bid computer 540 and perform a market clearing process for each available promotion slot to determine a content promotion for promoting in that slot, and present the content promotion to a user in that promotion slot. Depending on the bid price compared to the bid price provided by other content providers, content provider 102 may win at least a portion of the bid upon impressions. In some embodiments, presenting the electronic content may comprise receiving an impression request from content provider 102 by way of network 110, and sending it to a publisher 104 for inserting content from content server 106 into a web page provided by publisher 104. One of skill will understand that other arrangements are possible as well.

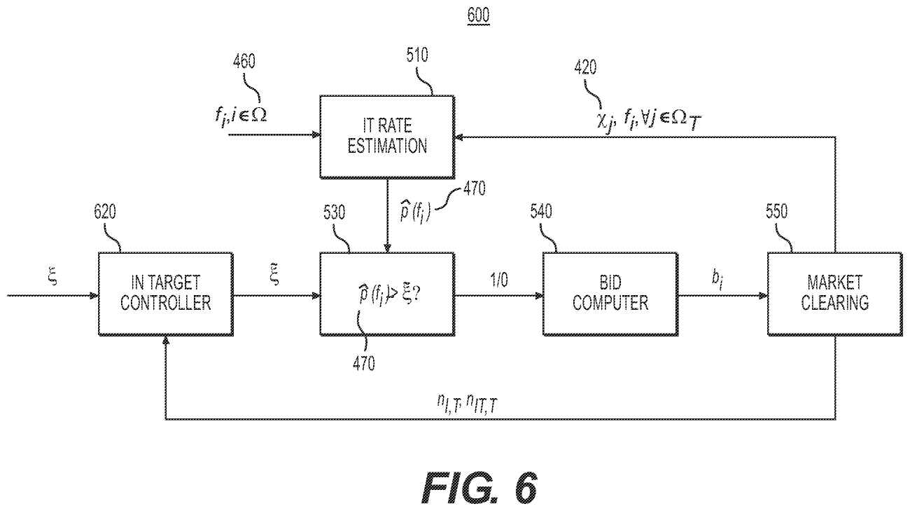

The marketplace for providing electronic impressions to users may involve providing many millions of such impressions within short periods of time. As such, a human operator cannot practically compete with automated systems for bidding upon and providing electronic impressions to users. FIG. 6 is a block diagram of a portion of an illustrative optimization control system 600, for automatically controlling optimization of an electronic content delivery campaign for non-measurable users, according to one or more embodiments. Generally, an electronic content delivery campaign may be used to provide content to both measurable and non-measurable users. However, an optimization control system, such as optimization control systems 500, 600, or 1000 discussed below, may include training of an in-target probability prediction model for “in-target estimation.” Through this training phase, a distinction may be made between measurable and non-measurable users. However, once the model is trained, such as based on historical impressions associated with measurable users, the delivery of electronic content may be applied similarly to all users whether or not the users are measurable. As shown in FIG. 6, the actions of manual controller 520 are performed by automated in-target controller 620 at speeds and in numbers that cannot be performed in the human mind or with pencil and paper. In addition, application of an automated in-target controller may allow for the control of a large number of campaigns—tens of thousands or more—and the employment of algorithmic learning techniques, including for example, machine learning, to optimize some adjustments applied to campaigns, such as, for example, whether large or small adjustments to campaign-level in-target rate control signal \tilde{ξ} are adequate.

FIG. 7 depicts a flowchart of a method 700 of optimizing electronic content delivery for non-measurable users, according to one or more embodiments, such as may be performed by optimization control system 600, for automatically controlling optimization of an electronic content delivery campaign for non-measurable users.

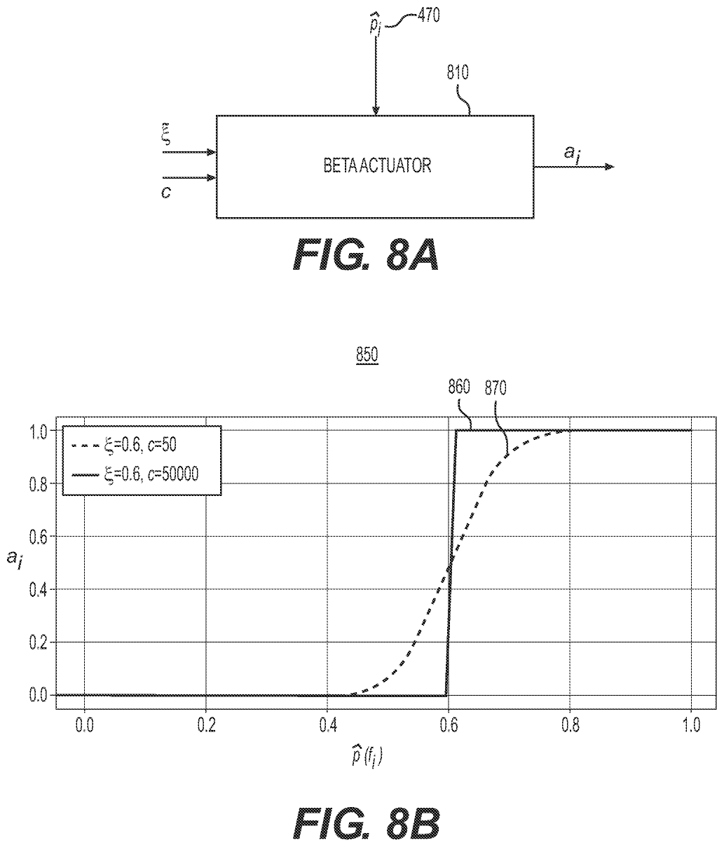

As shown in FIG. 7, at operation 705, an optimization control system, such as optimization control system 108 depicted in FIG. 2 and in greater detail in FIGS. 5 and 6, may receive a feature vector fᵢ of attributes for each impression opportunity i in a dataset of impression opportunities Ω. In some embodiments, an in-target estimation module of the optimization control system, such as in-target estimation module 510, may receive the feature vectors. At operation 710, the optimization control system may receive or generate, for each impression j among all impressions Ω_{T} for measurable users in the current campaign, an indication χj whether impression j was in-target and a corresponding feature vector fⱼ. In some embodiments, the indications χj and the feature vectors fⱼ may be generated by a component of the optimization control system, such as market clearing module 550, depicted in FIG. 5. At operation 715, the optimization system may estimate probability p\hat{ } that an impression opportunity will be in-target based on a corresponding user feature vector. At operation 720, the optimization system may receive desired in-target rate ξ specifying a minimum percentage of awarded impressions that are expected to be “in-target” based on desired user attributes specified by a content provider, such as content provider 102. At operation 725, the optimization system may determine campaign-level control signal \tilde{ξ}, to be applied as a threshold condition, based on a number n_{I,T} of awarded impressions delivered to measurable users in the current campaign—i.e., the number of measurable impressions—and a number n_{IT,T} of in-target impressions among the measurable impressions in the current campaign. At operation 730, it may be determined whether the estimated probability p\hat{ } that an impression will be in-target meets or exceeds the campaign-level control signal \tilde{ξ}. The determination may be made according to a method such as the one depicted in FIG. 8. At operation 735, the optimization system may, such as by bid computer 540, generate a bid for awarding impression based, in part, of the determination whether the estimated probability p\hat{ } that an impression will be in-target meets or exceeds the campaign-level control signal \tilde{ξ}. At operation 740, the optimization system may, such as by bid computer 540, submit the bid to a market for delivering electronic content impressions to users. At operation 745, the optimization system may, such as by market clearing module 550, determine awarded impressions delivered to users for winning bids at market. At operation 750, the optimization system may, such as by market clearing module 550, determine a feature vector fⱼ for each awarded impression χj for a measurable user. At operation 755, the optimization system may, such as by “in-target” rate estimation module 510, update the estimated probability p\hat{ } that an impression will be in-target based on the feature vector fⱼ for each awarded impression χj for a measurable user. At operation 760, the optimization system may, such as by market clearing module 550, update a number n_{I,T} of total awarded impressions for measurable users based on the awarded impressions χj for measurable users. At operation 765, the optimization system may, such as by market clearing module 550, update a number n_{IT,T} of awarded in-target impressions for measurable users based on the awarded impressions χj for measurable users. At operation 770, the optimization system may return to operation 725 to determine a further adjusted control signal \tilde{ξ} and process additional impression opportunities.

In some circumstances, updating the campaign-level control signal \tilde{ξ} may result in an abrupt change in observed in-target rate. Thus it may be desired to provide a mechanism to make the relationship between the campaign-level control signal and estimated campaign-level in-target rate smooth. FIG. 8A is a block diagram of a beta actuator 810, which may be employed in place of determination 530 in optimization control system 108 depicted in FIGS. 5 and 6. Adjustments in the control signal \tilde{ξ} according to beta actuator 810 may reduce challenges in design optimization control system 108 and may improve the in-target rate control performance of optimization control system 108.

As shown in FIG. 8A, beta actuator 810 may receive as input, in-target rate prediction \hat{p}(fᵢ) for an incoming impression opportunity i having an associate feature vector fᵢ, i.e., the estimated probability that the impression opportunity will become an in-target impression. In-target rate prediction \hat{p}(fᵢ) may be provided, for example, by a prediction model, such as an “in-target” rate estimation module 510, based on machine learning algorithms that are trained by historic impression data, as discussed above with respect to FIG. 5. Beta actuator 810 may also receive as input, the in-target rate control signal \tilde{ξ}, such as may be generated by in-target rate controller 520, as discussed above with respect to FIG. 5. Finally, beta actuator 810 may also receive as input, a configuration parameter c for beta actuator 810.

In contrast to determination 530 depicted in FIG. 5, which produces a binary (1/0, true/false) output, the output of beta actuator 810 may be a bid allocation signal aᵢ, which may be in the range between 0 and 1, and which may be used to determine if a particular impression opportunity i is dropped (no further action) or not (proceed to bidding). In particular, an impression opportunity i with a predicted in-target rate \hat{p}(fᵢ) may have a probability aᵢ of proceeding to bidding. Note the value of aᵢ depends on the in-target rate control signal \tilde{ξ} and the predicted in-target rate \hat{p}(fᵢ) of the impression opportunity i. With a given in-target rate control signal \tilde{ξ} and c, the relationship between aᵢ and \hat{p}(fᵢ) may be, for example, a static mapping. FIG. 8B includes a plot 850 that shows a relationship between aᵢ and \hat{p}(fᵢ), such as a static mapping between aᵢ and \hat{p}(fᵢ), for a given \tilde{ξ} as 0.6 and c as 50 and 50,000, respectively.

The configuration parameter c may have, for example, an impact on the “steepness” of the curve. In fact, as c approaches infinity, a smooth curve, such as, for example, at \hat{p}(fᵢ)=0.6 and c=50, as shown in plot 870, may become close to a step function (for example, at \hat{p}(fᵢ)=0.6 and c=50,000, as shown in plot 860). In this regard, the beta actuation may be considered as a “soft” thresholding mechanism.

With a configuration of \tilde{ξ}=0.6 and c=50, if an incoming impression opportunity is predicted (by the machine learning prediction model) to have an in-target rate of \hat{p}(fᵢ)=0.6, then aᵢ=0.5 from the static mapping as shown in FIG. 8B, meaning it has a 0.5 probability of proceeding to bidding. In other words, out of 100 incoming impression opportunities with the same in-target rate prediction \hat{p}(fᵢ)=0.6, 50 will be dropped, and 50 will proceed to bidding.

On the other hand, as shown in FIG. 8B, if an incoming impression opportunity is predicted to have an in-target rate of \hat{p}(fᵢ)=0.8, then a approaches 1.0 from the static mapping, meaning it will almost for sure proceed to bidding. In other words, out of 100 incoming impression opportunities with the same in-target rate prediction \hat{p}(fᵢ)=0.8 (or above), almost all of them will proceed to bidding.

Furthermore, if an incoming impression opportunity is predicted to have an in-target rate of \hat{p}(fᵢ)=0.4, then aᵢ approaches 0 from the static mapping, meaning it will almost certainly be dropped without further action. In other words, out of 100 incoming impression opportunities with the same in-target rate prediction \hat{p}(fᵢ)=0.4 (or below), almost none will proceed to bidding.

In practice, when the campaign controller is running, the control signal may be adjusted by an administrator, and the curve (as shown in FIG. 8B) may, for example, shift to the left or to the right. For example, when controller ramps up the control signal \tilde{ξ}, the curve would shift to the right. As a result, more and more impression opportunities with a low in-target rate prediction \hat{p}(fᵢ) would be dropped (due to small aᵢ). A higher in-target rate at the campaign level can thus be expected.

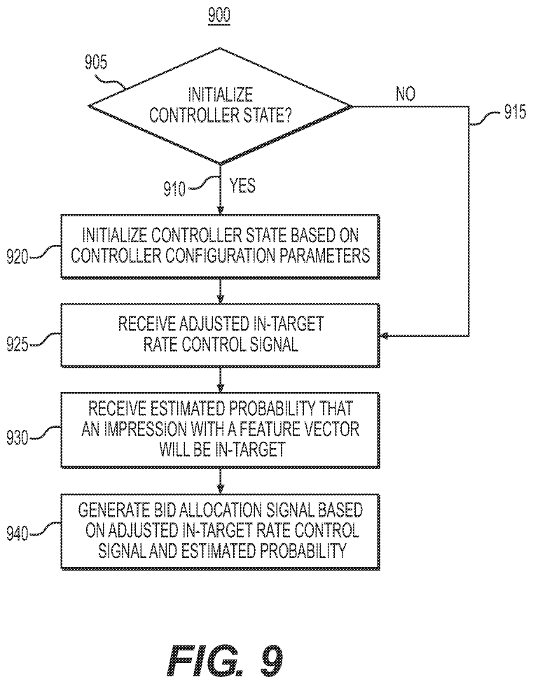

FIG. 9 is a flowchart of a method 900 of generating a bid allocation signal in a method of optimizing electronic content delivery for non-measurable users, according to one or more embodiments. As shown in FIG. 9, at operation 905 it may be determined whether to initialize a controller state. For example, a first invocation of method 900 may require an initialization of a controller state. If the controller state requires initialization then at operation 910, method 900 may flow to operation 920. Otherwise, at operation 915, method 900 may flow to block 925. At operation 920, the optimization system may initialize the controller state based on one or more controller configuration parameters. At operation 925, the optimization system may receive an adjusted in-target rate control signal. At operation 930, the optimization system may receive an estimated probability that an impression if delivered to a user with an associated feature vector will be in-target. At operation 940, the optimization system may generate a bid allocation signal based on the adjusted in-target rate control signal and the estimated probability. The generated bid allocation signal may then be provided to a bid computer, such as bid computer 540 depicted in FIG. 5

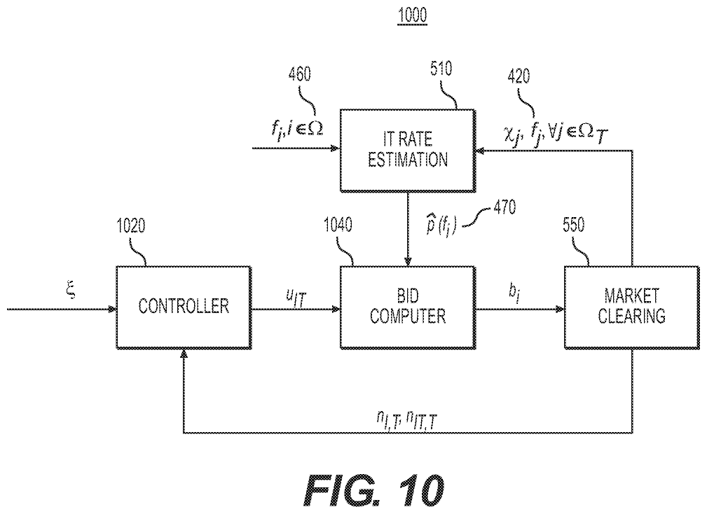

Delivery of electronic content may be further optimized through consideration of an estimated probability p\hat{ } that an impression will be in-target in the bid determination. In such a system, an automated in-target controller may provide a control signal to a bid computer to further control the bid determination. FIG. 10 is a block diagram of a portion of an illustrative optimization control system 1000, for automatically controlling optimization of an electronic content delivery campaign for non-measurable users, according to one or more embodiments. In such an optimization control system, the computed in-target probability p\hat{ } and the threshold control signal μ_{IT} may be used to compute the bid price, as opposed to the bid allocation. This may enable a more nuanced optimization where not only the event rate is considered, but multiple optimization objectives simultaneously, such as minimizing the average cost per in target impression, or a constraint on the average cost per in target impression be no larger than a predetermined threshold. As shown in FIG. 10, “in-target” rate estimation module 510 and market clearing module 550 may operate as discussed above with respect to FIG. 5. Automated in-target controller 1020 may receive, such as from content provider 102, an in-target threshold value specifying a minimum percentage of awarded impressions that are deemed to be “in-target” based on content provider 102's desired user attributes. In-target controller 1020 may also receive, from market clearing module 550, a number n_{I,T} of awarded impressions delivered to measurable users in the current campaign—i.e., the number of measurable impressions—and a number n_{IT,T} of the number of in-target impressions among the measurable impressions in the current campaign. Based on the received information, in-target controller 1020 may generate an “in-target” control signal μ_{IT} to be provided to bid computer 1040. “In-target” control signal μ_{IT} may be, for example, a value between zero and 1, 0≤μ_{IT}≤1. The “in-target” control signal μ_{IT} can be updated by in-target controller 1020 based, at least in part, on the in-target threshold value ξ, the number n_{I,T} of awarded impressions delivered to measurable users in the current campaign, and the number n_{IT,T} of the number of in-target impressions among the measurable impressions in the current campaign. The “in-target” control signal μ_{IT} may be an estimate for the campaign-level “in-target” rate. In-target controller 1020 may enable or employ at least portions of process 800 of FIG. 8 to update the control signal. Bid computer 1040 may submit a bid for the impression based on the “in-target” control signal μ_{IT}, an estimated probability p\hat{ } that an impression will be in-target, as determined by estimation module 510, and other factors such as, for example, details of the impression, a predetermined bidding strategy, and the competitive landscape. Further details of the bid calculation are beyond the scope of this disclosure.

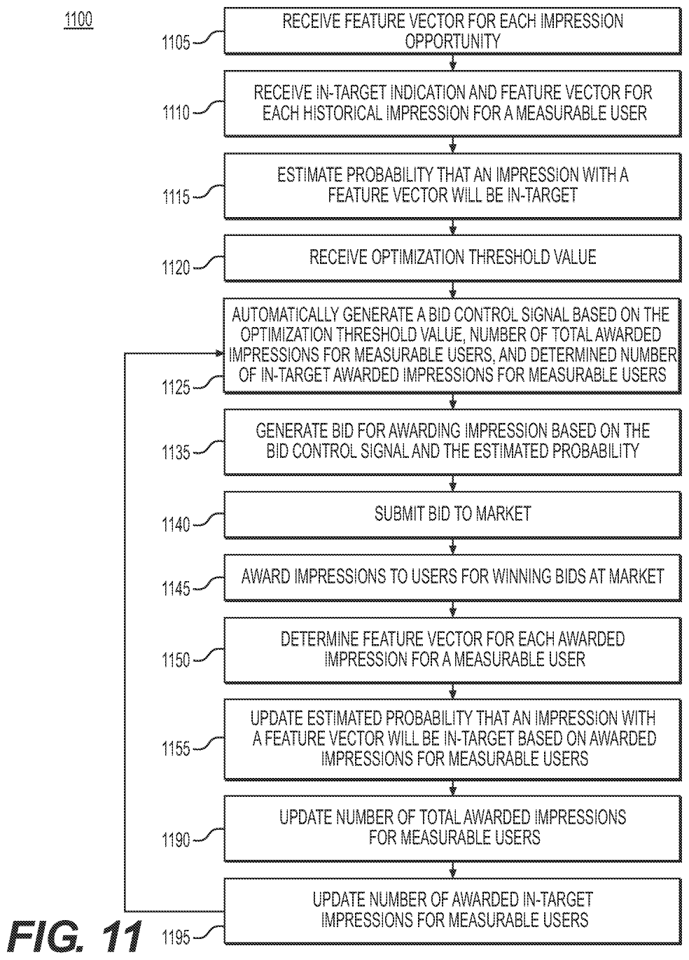

FIG. 11 depicts a flowchart of a method of optimizing electronic content delivery for non-measurable users, according to one or more embodiments. As shown in FIG. 11, at operation 1105, a optimization system, such as optimization control system 108 depicted in FIG. 2 and in greater detail in FIG. 9, may receive a feature vector fᵢ of attributes for each impression opportunity i in a dataset of impression opportunities Ω. At operation 1110, the optimization system may receive or generate, for each impression j among all impressions Ω_{T} for measurable users in the current campaign, an indication χj whether impression j was in-target and a corresponding feature vector fⱼ. In some embodiments, the indications χj and the feature vectors fⱼ may be generated by a component of the optimization control system, such as market clearing module 550, depicted in FIG. 5. At operation 1115, the optimization system may estimate probability p\hat{ } that an impression opportunity will be in-target based on a corresponding user feature vector. At operation 1120, the optimization system may receive desired in-target rate ξ specifying a minimum percentage of awarded impressions that are expected to be “in-target” based on desired user attributes specified by a content provider, such as content provider 102.

At operation 1125, the optimization system may automatically generate a bid control signal μ_{IT} based on the desired in-target rate a number n_{I,T} of awarded impressions delivered to measurable users in the current campaign—i.e., the number of measurable impressions—and a number n_{IT,T} of the number of in-target impressions among the measurable impressions in the current campaign. “In-target” control signal μ_{IT} may be, for example, a value between zero and 1, 0≤μ_{IT}≤1, and may be a threshold value for impression opportunities to bid on in order to achieve a desired campaign-level “in-target” rate. The optimization system may enable or employ at least portions of process 800 of FIG. 8 to update the “in-target” control signal μ_{IT}.

At operation 1135, the optimization system may generate bid for awarding impression based on the “in-target” control signal μ_{IT} and the estimated probability p\hat{ } that an impression will be in-target. At operation 1140, the optimization system may submit the bid to a market for delivering electronic content impressions to users. At operation 1145, the optimization system may determine awarded impressions delivered to users for winning bids at market. At operation 1150, the optimization system may determine feature vector for each awarded impression for a measurable user. At operation 1155, the optimization system may update estimated probability p\hat{ } that an impression with a feature vector will be in-target based on awarded impressions for measurable users. At operation 1190, the optimization system may update the number n_{I,T} of total awarded impressions for measurable users. At operation 1195, the optimization system may update the number n_{IT,T} of awarded in-target impressions for measurable users, and return to operation 1125 to determine an updated “in-target” control signal μ_{IT} and process additional impressions.

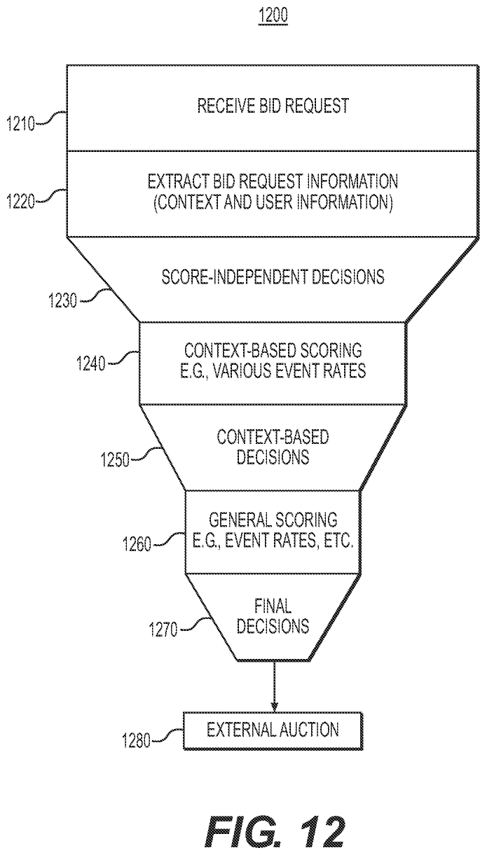

Prior to submitting offers or bids to an external impression marketplace auction, an internal process may be performed to determine potential impression opportunities for which offers or bids may be submitted to an external auction. Such an internal auction process may further optimize delivered impressions based on in-target criteria. FIG. 12 depicts a process flow of a method 1200 of optimizing electronic content delivery for non-measurable users, according to one or more embodiments. As shown in FIG. 12, at operation 1210, an optimization system, such as optimization control system 108 depicted in FIG. 2 and in greater detail in FIGS. 5, 6, and 9, may receive an offer or bid request for incoming impression opportunities. At operation 1220, the optimization system may extract offer or bid request information, such as, for example, the context of the impression opportunity and user information for potentially targeted users. At operation 1230, the optimization system may perform score-independent decisions, such as pacing of impression delivery, sometimes referred to as rate throttling, and other filtering of potential offer or bid requests. These decisions may be considered a first stage of reducing the number of offers or bids. At operation 1240, the optimization system may perform context-based scoring, such as “inexpensive” scores that only depend on context features and not on user profiles and preferably not on impression context profiles. Such decisions may include computation of one or more event rates, such as, for example, a context-based in-target rate, such as a rate of meeting frequency capping requirements, or a context-based prediction of a rate of meeting a predicted target audience. At operation 1250, the optimization system may perform context-based decisions, such as, for example, computing an offer- or bid-level allocation rate based on context-based scores, control signals, and configuration parameters (e.g. thresholding or beta actuation related to frequency capping control), throttling based on a computed allocation rate, etc. These decisions may be considered a second stage of reducing the number of offers or bids. At operation 1260, the optimization system may perform general scoring to compute scores that depend on a large number of user and context features, such as, for example, computing a user-based click-through rate, a user-based conversion rate, or an impression value (e.g. one of the above or a combination of brand and performance value). At operation 1270, the optimization system may make final bid decisions, such as by computing a bid-level allocation rate based on general scores, control signals, and configuration parameters, throttling based the computed allocation rate, computing a bid price based on general scores, control signals, and configuration parameters, and conducting an internal auction based on the computed bid prices for all remaining bidders. These decisions may be considered a third stage of reducing the number of offers or bids. Remaining bids may be submitted to an external auction at operation 1280.

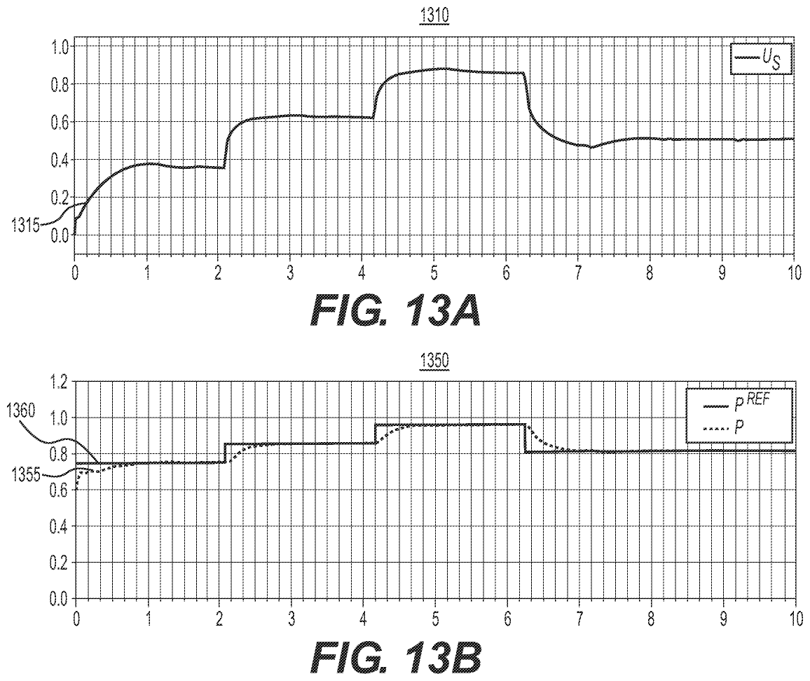

FIGS. 13A and 13B relate to an example of an in-target rate controller response, according to one or more embodiments, for a campaign that runs over a period of 10 days. In this context, an impression is in target if it does not violate user-specific criteria, such as a frequency capping requirement. For example, a user should not be expected to be exposed to the same electronic content more than a specified number of times over a specified period, such as, for example, four times over a 24-hour period. An impression is in-target if the impression served to a particular user is the first, second, third, or fourth time the impression has been shown to this user over the past 24-hour period. It would be a violation if this is the fifth or more time it has been shown to this user over the past 24 hour period. In-target rates at the campaign level may be computed as the ratio of the total number of in-target impressions and the total number of awarded impressions in the campaign.

FIG. 13A includes a plot 1310 that shows an optimization control signal for a method of optimizing electronic content delivery for non-measurable users, according to one or more embodiments. FIG. 13B includes a plot 1350 that shows a time series of a specified in-target rate reference p^{REF} 1360 and a campaign-level in-target rate estimate p 1355 for a method of optimizing electronic content delivery for non-measurable users, according to one or more embodiments. As shown in FIGS. 13A and 13B, an in-target rate reference 1360, shown in FIG. 13B, may be specified and may be varied at the campaign level by the user, such as, for example, an electronic content provider or their agent, during the 10-day period. In this example, the campaign-level reference may initially be set as 0.75 for day zero and day 1, meaning that at least 75% of all impressions awarded in this campaign are expected by the user to be in target. The in-target rate controller ramps up the control signal 1315, shown in FIG. 13A, from an initial value of 0.00 to about 0.35. As a result, the observed in-target rate 1355, shown in FIG. 13B, may rise and remain around 0.75. On day two, the reference 1360 may be changed by the user to 0.85, and the controller may respond by ramping up control signal 1315 to around 0.6, resulting in an observed in-target rate 1355 at and around 0.85. Similar behavior of the controller may be seen for day four and day five, when the in-target rate reference 1360 is further increased to 0.95. On day six, the in-target rate reference 1360 may be reduced to 0.8, the controller may respond by ramping down the control signal 1315 to around 0.5, resulting in an observed in-target rate 1355 at and around 0.8.

Note that, as discussed above, the campaign-level in-target rate controller may adjust itself in an automatic manner to meet the campaign-level in-target rate reference specified by content provider 102 or their agent. The control signal generated by the controller may be different from the in-target rate reference. The actual level of the control signal may be dictated by factors such as the accuracy of the in-target rate predictions. In this regard, the controller may compensate for the uncertainties in the in-target rate predictions to meet the in-target rate specification.

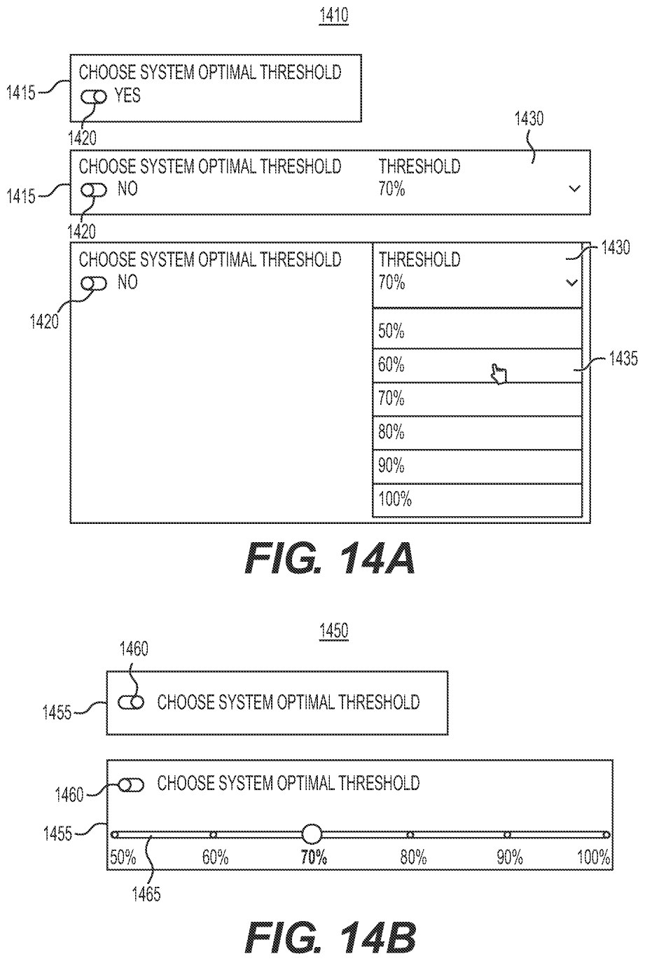

As discussed above, a user, such as a content provider, may specify an desired in-target rate for delivering electronic content impressions to users. FIGS. 14A and 14B depict user interfaces for user control of an desired in-target rate in a method of optimizing electronic content delivery for non-measurable users, according to one or more embodiments. As shown in FIG. 14A, a user interface 1415 may be provided to allow a user to control an in-target rate control signal. For example, user interface 1415 may allow a user to specify whether a threshold should be automatically determined or specified manually. This section may be specified by a pushbutton or slider 1420, or by any other user interface element, such as would be known to one of ordinary skill. If the user selects not to automatically determine the threshold, a user interface element 1430, such as, for example, a drop-down list, may be displayed to allow the user to specify a value. For example, the user may select a value 1435 specifying a 60% desired in-target rate. Other arrangements of user interface elements are possible. As another non-limiting example, a user interface 1455 may include a selector 1460 to allow a user to specify whether a threshold should be automatically determined or specified manually. If the user selects not to automatically determine the threshold, a user interface element, such as, for example, a slider 1465, may be displayed to allow the user to specify a value

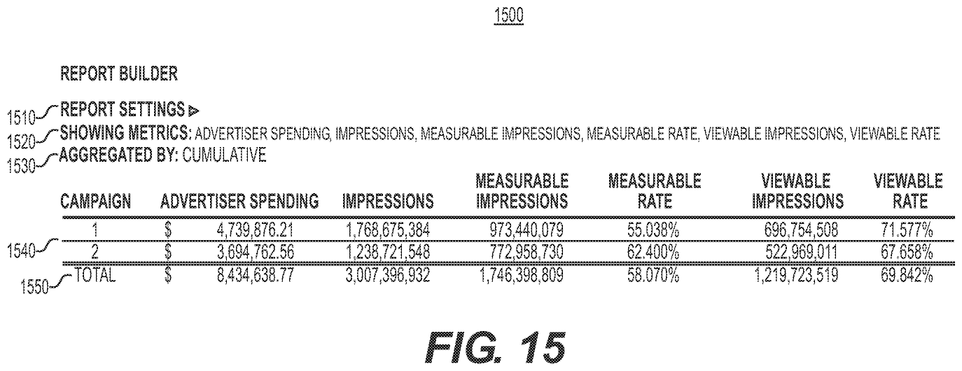

FIG. 15 depicts a user interface 1500 for user control for generating reports of an electronic content delivery campaign in a method of optimizing electronic content delivery for non-measurable users, according to one or more embodiments. As shown in FIG. 15, a user, such as a content provider, may determine statistics for one or more campaigns to display. For example, the user may select to change report settings through a user interface element 1510. The campaign metrics selected for display may be shown in list 1520, and a method of aggregating statistics for multiple campaigns may be shown in user interface element 1520. The report may include separate rows 1540 for each campaign. If a method for aggregating multiple campaigns is specified, the aggregated values may be shown in a summary row 1550.

### Generalized Computing Device

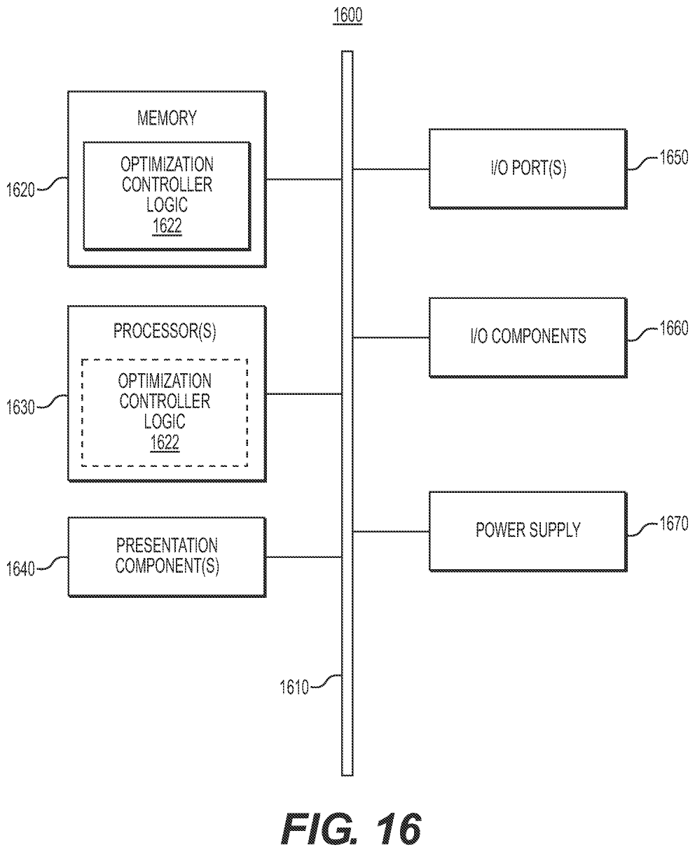

With reference to FIG. 16, computing device 1600 may include a bus 1610 that directly or indirectly couples the following devices: memory 1620, one or more processors 1630, one or more presentation components 1640, input/output (I/O) ports 1650, I/O components 1660, and an illustrative power supply 1670. Bus 1610 represents what may be one or more busses (such as an address bus, data bus, or combination thereof). Although depicted in FIG. 16, for the sake of clarity, as delineated boxes that depict groups of devices without overlap between these groups of devices, in reality this delineation is not so clear cut and a device may well fall within multiple ones of these depicted boxes. For example, one may consider a display to be one of the one or more presentation components 1640 while also being one of the I/O components 1660. As another example, processors have memory integrated therewith in the form of cache; however, there is no overlap between the one or more processors 1630 and the memory 1620. A person of ordinary skill in the art will readily recognize that such is the nature of the art, and it is reiterated that the diagram of FIG. 16 merely depicts an illustrative computing device that can be used in connection with one or more embodiments of the present invention. It should also be noticed that distinction is not made between such categories as “workstation,” “server,” “laptop,” “hand-held device,” etc., as all such devices are contemplated to be within the scope of computing device 1600 of FIG. 16 and any other reference to “computing device,” unless the context clearly indicates otherwise.

Computing device 1600 may include a variety of computer-readable media. Computer-readable media can be any available media that can be accessed by computing device 1600 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1620 may include computer-storage media in the form of volatile and/or nonvolatile memory. The memory may be removable, non-removable, or a combination thereof. Typical hardware devices may include, for example, solid-state memory, hard drives, optical-disc drives, etc. Computing device 1600 may include one or more processors 1630 that read data from various entities such as memory 1620 or I/O components 1660. Presentation component(s) 1640 may present data indications to a user or other device. Illustrative presentation components may include a display device, speaker, printing component, vibrating component, etc.

In various embodiments, memory 1620 may include, in particular, temporal and/or persistent copies of optimization controller logic 1622. Optimization controller logic 1622 may include instructions that, when executed by one or more processors 1630, result in computing device 1600 performing any of the processes and/or actions described above in reference to optimization control system 108 of FIGS. 1-2, optimization control systems 600 and 900 of FIGS. 6 and 9, respectively, or processes 700, 800, and 1000 of FIGS. 7, 8, and 10, respectively.

In some embodiments, one or more processors 1630 may be packaged together with optimization controller logic 1622. In some embodiments, one or more processors 1630 may be packaged together with optimization controller logic 1622 to form a System in Package (SiP). In some embodiments, one or more processors 1630 can be integrated on the same die with optimization controller logic 1622. In some embodiments, processor 1630 can be integrated on the same die with optimization controller logic 1622 to form a System on Chip (SoC).

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for optimizing electronic content delivery for non-measurable users, the method comprising:
receiving a feature vector for each electronic content impression opportunity among a plurality of electronic content impression opportunities;
receiving a feature vector for each delivered item of electronic content among a plurality of previously-delivered items of electronic content for measurable users;
receiving an in-target indication for each delivered item of electronic content among the plurality of previously-delivered items of electronic content for measurable users;
estimating a probability that an electronic content impression opportunity among the plurality of electronic content impression opportunities with a specified feature vector will meet targeting requirements based on the received feature vectors and the received in-target indications;
receiving a desired in-target rate;
generating an in-target rate control signal based on a number of total delivered items of electronic content for measurable users and a number of in-target delivered items of electronic content for measurable users;
determining whether the estimated probability is greater than the in-target rate control signal; and
generating conditions for delivering a new item of electronic content for an electronic content impression opportunity among the plurality of electronic content impression opportunities.

2. The computer-implemented method of claim 1, further comprising:
determining a feature vector for a new delivered item of electronic content for a measurable user;
updating the estimated probability that an electronic content impression opportunity among the plurality of electronic content impression opportunities with the specified feature vector will meet targeting requirements based on the new delivered item of electronic content for a measurable user;
updating the number of total delivered items of electronic content for measurable users based on the new delivered item of electronic content for a measurable user;
updating the number of in-target delivered items of electronic content for measurable users based on the new delivered item of electronic content for a measurable user; and
adjusting the in-target rate control signal based on the updated number of total delivered items of electronic content for measurable users and the updated number of in-target delivered items of electronic content for measurable users.

3. The computer-implemented method of claim 1, wherein the targeting requirements include one or more of a requirement that the electronic content is delivered to a user up to a specified maximum number of times within a specified period of time, a requirement that demographics of a user receiving the electronic content match predetermined demographics, a requirement that prior behavior and activity of the user receiving the electronic content match predetermined behavior and activity criteria, and a requirement that repeated delivery of the electronic content to a user be separated by at least a specified period of time.

4. The computer-implemented method of claim 3, wherein the specified period of time is one of an hour, a number of hours, a day, or a number of days.

5. The computer-implemented method of claim 1, wherein the measurable users are a subset of all users receiving the electronic content, and
wherein receipt of the electronic content by the measurable users is recorded.

6. The computer-implemented method of claim 1, wherein the measurable users are determined by way of an opt-in by each measurable user among the measurable users, and
wherein each measurable user among the measurable users is measured by way of one or more of a device identifier of a device of the measurable user, or a hashed email address of the measurable user.

7. The computer-implemented method of claim 1, wherein generating the conditions for delivering a future item of electronic content is based on a binary result of determining if the estimated probability is greater than the in-target rate control signal.

8. The computer-implemented method of claim 1, wherein generating the conditions for delivering a future item of electronic content is based on the estimated probability.

9. A system for optimizing electronic content delivery for non-measurable users, the system comprising:
a data storage device storing instructions for optimizing electronic content delivery for non-measurable users in an electronic storage medium; and
a processor configured to execute the instructions to perform a method including:
receiving a feature vector for each electronic content impression opportunity among a plurality of electronic content impression opportunities;
receiving a feature vector for each delivered item of electronic content among a plurality of previously-delivered items of electronic content for measurable users;
receiving an in-target indication for each delivered item of electronic content among the plurality of previously-delivered items of electronic content for measurable users;
estimating a probability that an electronic content impression opportunity among the plurality of electronic content impression opportunities with a specified feature vector will meet targeting requirements based on the received feature vectors and the received in-target indications;
receiving a desired in-target rate;
generating an in-target rate control signal based on a number of total delivered items of electronic content for measurable users and a number of in-target delivered items of electronic content for measurable users;
determining whether the estimated probability is greater than the in-target rate control signal; and
generating conditions for delivering a new item of electronic content for an electronic content impression opportunity among the plurality of electronic content impression opportunities.

10. The system of claim 9, wherein the system is further configured for:
determining a feature vector for a new delivered item of electronic content for a measurable user;
updating the estimated probability that an electronic content impression opportunity among the plurality of electronic content impression opportunities with the specified feature vector will meet targeting requirements based on the new delivered item of electronic content for a measurable user;
updating the number of total delivered items of electronic content for measurable users based on the new delivered item of electronic content for a measurable user;
updating the number of in-target delivered items of electronic content for measurable users based on the new delivered item of electronic content for a measurable user; and
adjusting the in-target rate control signal based on the updated number of total delivered items of electronic content for measurable users and the updated number of in-target delivered items of electronic content for measurable users.

11. The system of claim 9, wherein the targeting requirements include one or more of a requirement that the electronic content is delivered to a user up to a specified maximum number of times within a specified period of time, a requirement that demographics of a user receiving the electronic content match predetermined demographics, a requirement that prior behavior and activity of the user receiving the electronic content match predetermined behavior and activity criteria, and a requirement that repeated delivery of the electronic content to a user be separated by at least a specified period of time.

12. The system of claim 9, wherein the measurable users are a subset of all users receiving the electronic content, and
wherein receipt of the electronic content by the measurable users is recorded.

13. The system of claim 9, wherein the measurable users are determined by way of an opt-in by each measurable user among the measurable users, and
wherein each measurable user among the measurable users is measured by way of one or more of a device identifier of a device of the measurable user, or a hashed email address of the measurable user.

14. The system of claim 9, wherein generating the conditions for delivering a future item of electronic content is based on a binary result of determining if the estimated probability is greater than the in-target rate control signal.

15. A non-transitory machine-readable medium storing instructions that, when executed by a computing system, causes the computing system to perform a method for optimizing electronic content delivery for non-measurable users, the method including:
receiving a feature vector for each electronic content impression opportunity among a plurality of electronic content impression opportunities;
receiving a feature vector for each delivered item of electronic content among a plurality of previously-delivered items of electronic content for measurable users;
receiving an in-target indication for each delivered item of electronic content among the plurality of previously-delivered items of electronic content for measurable users;
estimating a probability that an electronic content impression opportunity among the plurality of electronic content impression opportunities with a specified feature vector will meet targeting requirements based on the received feature vectors and the received in-target indications;
receiving a desired in-target rate;
generating an in-target rate control signal based on a number of total delivered items of electronic content for measurable users and a number of in-target delivered items of electronic content for measurable users;
determining whether the estimated probability is greater than the in-target rate control signal; and
generating conditions for delivering a new item of electronic content for an electronic content impression opportunity among the plurality of electronic content impression opportunities.

16. The non-transitory machine-readable medium of claim 15, the method further comprising:
determining a feature vector for a new delivered item of electronic content for a measurable user;
updating the estimated probability that an electronic content impression opportunity among the plurality of electronic content impression opportunities with the specified feature vector will meet targeting requirements based on the new delivered item of electronic content for a measurable user;
updating the number of total delivered items of electronic content for measurable users based on the new delivered item of electronic content for a measurable user;
updating the number of in-target delivered items of electronic content for measurable users based on the new delivered item of electronic content for a measurable user; and
adjusting the in-target rate control signal based on the updated number of total delivered items of electronic content for measurable users and the updated number of in-target delivered items of electronic content for measurable users.

17. The non-transitory machine-readable medium of claim 15, wherein the targeting requirements include one or more of a requirement that the electronic content is delivered to a user up to a specified maximum number of times within a specified period of time, a requirement that demographics of a user receiving the electronic content match predetermined demographics, a requirement that prior behavior and activity of the user receiving the electronic content match predetermined behavior and activity criteria, and a requirement that repeated delivery of the electronic content to a user be separated by at least a specified period of time.

18. The non-transitory machine-readable medium of claim 15, wherein the measurable users are a subset of all users receiving the electronic content, and
wherein receipt of the electronic content by the measurable users is recorded.

19. The non-transitory machine-readable medium of claim 15, wherein the measurable users are determined by way of an opt-in by each measurable user among the measurable users, and
wherein each measurable user among the measurable users is measured by way of one or more of a device identifier of a device of the measurable user, or a hashed email address of the measurable user.

20. The non-transitory machine-readable medium of claim 15, wherein generating the conditions for delivering a future item of electronic content is based on the estimated probability.
